(19) United States
(12) Patent Application Publication
(10) Pub. No.: US 2009/0109671 A1
(43) Pub. Date: Apr. 30, 2009

(54) LED LAMP HAVING A HEAT DISSIPATION DEVICE INCORPORATING A HEAT PIPE STRUCTURE THEREIN

(75) Inventors: Fang-Xiang Yu, Shenzhen City (CN); Shun-Yuan Jan, Tu-Cheng (TW); Chung-Yuan Huang, Santa Clara, CA (US)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/256,436

(22) Filed: Oct. 22, 2008

(30) Foreign Application Priority Data
Oct. 26, 2007 (CN) 200710124166.4

(51) Int. Cl. F21V 29/00

(52) U.S. Cl. 362/234

(57) ABSTRACT

An LED lamp (100) has a heat dissipation device (50) which includes a base (51) and a plurality of fins (53) extending from an outer side of the base. The base includes two channels (553). A capillary wick structure is formed in each of the channels. The channels contain working liquid therein. Two ends of each channel are sealed to form a heat pipe structure (55) in the base.

### BACKGROUND

1. Field of the Invention

The present invention relates to an LED lamp, and more particularly to an LED lamp having a heat dissipation device for dissipating heat generated by LEDs of the LED lamp, wherein the heat dissipation device integrally forms a heat pipe structure therein.

2. Description of Related Art

With the continuing development of scientific technology and the raise of people's consciousness of energy saving, LEDs have been widely used in the field of illumination due to their small size and high efficiency. It is well known that an LED lamp with LEDs arranged side-by-side in large density generates a lot of heat when the LEDs emit light. For dissipating heat of the LED lamp, heat sink and heat pipe were commonly incorporated into the LED lamp. The heat pipe was secured to a bottom side of the heat sink, and the LEDs were attached to an outer surface of the heat pipe. However, because the outer surface of the heat pipe was not entirely flat, the LEDs could not contact the outer surface sufficiently. Thus, a gap was inevitably formed between the heat pipe and the LEDs to generate a thermal resistance so that the heat of the LED lamp could not be dissipated efficiently.

What is needed, therefore, is an LED lamp having a heat dissipation device which can dissipate the heat of the LEDs efficiently.

### SUMMARY

An LED lamp has a heat dissipation device which according to an exemplary embodiment includes a base and a plurality of fins extending from an outer side of the base. The base includes two channels therein. A capillary wick structure is formed in each of the channels. The channels contain working liquid therein. Two ends of each channel are sealed to form a heat pipe structure in the base.

Other advantages and novel features of the present invention will become more apparent from the following detailed description when taken in conjunction with the accompanying drawings.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an isometric, assembled view of an LED lamp in accordance with an exemplary embodiment.

FIG. 2 is similar to FIG. 1, wherein lids are separated from the LED lamp.

FIG. 3 is an enlarged, isometric view of a circled portion III-III of FIG. 2.

FIG. 4 is a flow chart of a method for manufacturing a heat dissipation device of the LED lamp shown in FIG. 1.

### DETAILED DESCRIPTION

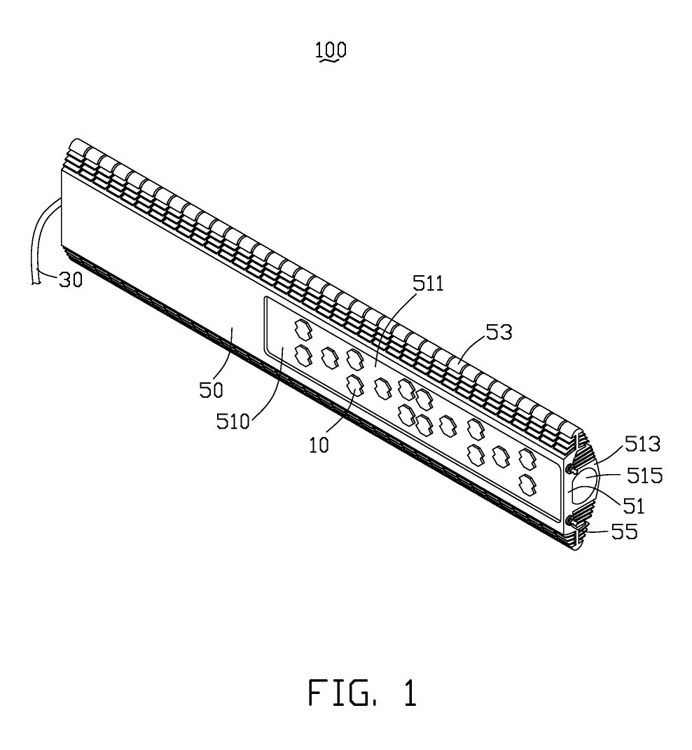

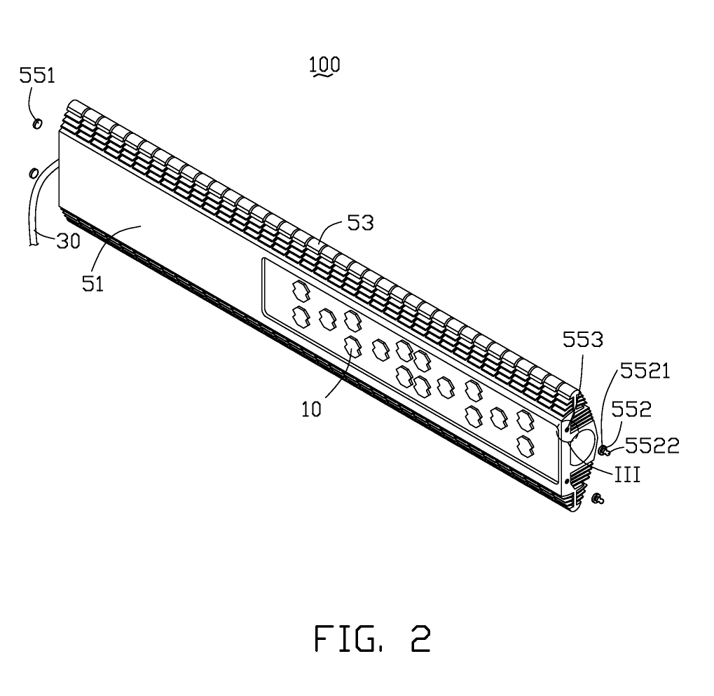

Referring to FIGS. 1-2, an LED lamp 100 in accordance with an exemplary embodiment is shown. The LED lamp 100 includes a heat dissipation device 50 and a plurality of LEDs 10. The LEDs 10 used as light source are located on a front side of the heat dissipation device 50 for emitting light.

The heat dissipation device 50 includes a base 51 and a plurality of fins 53. The fins 53 extend outwardly from upper and lower sides of the base 51 for exchanging heat with ambient air.

The base 51 has an elongated and rectangular shape. A rectangular recess 511 is defined in the front side of the base 51 and extends from a middle to a lateral edge thereof. The LEDs 10 are received in the recess 511 and arranged side-by-side in large density. The base 51 has a substantially flat mounting surface 510 at a bottom of the recess 511. The LEDs 10 are attached to the mounting surface 510. A protrusion 513 is formed on a middle of a rear side of the base 51 and extends all along the lengthwise direction of the base 51. A circular hole 515 is defined through the protrusion 513 along the lengthwise direction from left to right. A wire 30 is received in the hole 515 for supply power to the LEDs 10.

Two channels 553 are defined in the base 51. The channels 553 are small, circular holes and extend through the base 51 along the lengthwise direction from left to right. The channels 553 are spaced from each other. The channels 553 are located at positions adjacent to the front side and the upper and lower sides of the base 510 so that the channels 553 are adjacent to the LEDs 10 and the fins 53.

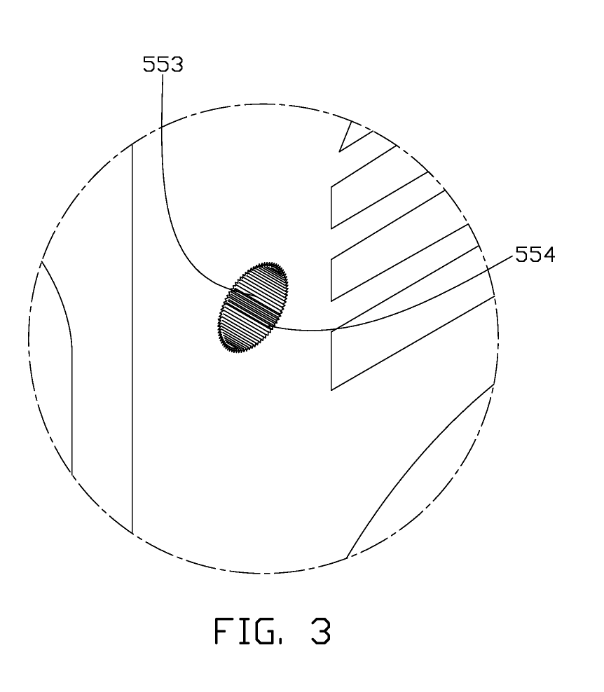

Referring to FIG. 3, a plurality of micro grooves are defined in each channel 553 so as to form a groove-type capillary wick structure 554 in the channel 553. Alternatively, the channels 553 can be made to have other type capillary wick structure, such as a sintered-type capillary wick structure, a meshed-type capillary wick structure, or a composite capillary wick structure. The channels 553 contain working liquid therein.

Two lids 551, 552 are respectively coupled to two ends of each channel 553 for sealing hermetically the channel 553 by soldering the lids 551, 552 to the base 51 at the two ends of each channel 553. The lid 551 has a round shape similar to a cross section of the channel 553. The lid 551 has a diameter greater than the channel 553, and attaches to the left side of the base 51 over the channel 553 to seal the left end of the channel 553. The lid 552 has a flat, round portion 5521 attaching to the right side of the base 51 around the right end of the channel 553 and a plug 5522 extending outwardly from a center of the flat, round portion 5521. The flat, round portion 5521 has a central hole (not shown) communicating with the channel 553, the plug 5522 is inserted and soldered in the central hole of the flat, round portion 5521 and seals the right end of the channel 553.

The channels 553, the capillary wick structures 554 and the lids 551, 552 cooperatively form two heat pipe structures 55 in the base 51. Because the heat pipe structures 55 are located adjacent to the LEDs 10 and the fins 53, and the heat pipe structures 55 extend through the base 51, heat generated by the LEDs 10 can be quickly transferred to the fins 53 and spread all over the heat dissipation device 50. Furthermore, the LEDs 10 have a sufficient contact with the flat mounting surface 510 so as to reduce thermal resistance between the LEDs 10 and the base 51. Thus, the heat of the LED lamp 100 can be dissipated more efficiently. The number of the heat pipe structures 55 can be more than two according to actual need.

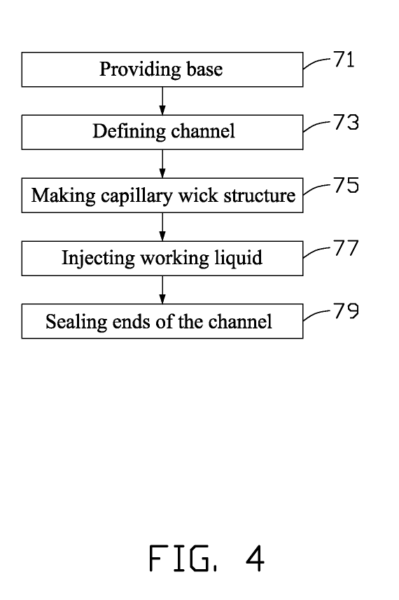

A method for manufacturing the heat pipe structures 55, as shown in FIG. 4, comprises steps of:
step 71: providing abase 51;
step 73: defining two channels 553 through the base 51;
step 75: making a plurality of micro grooves in each channel 553 so as to form groove-type capillary wick structure 554;
step 77: injecting working liquid into the channels 553; and
step 79: vacuuming the channels 553 and providing lids 551, 552 and sealing ends of the channels 79 with the lids 551, 552, thereby forming the desired heat pipe structures 55.

Step 71 is described in detail as follows: the base 51 with the fins 53 is manufactured by extruding a piece of aluminum material.

Step 73 is described in detail as follows: the extruding method is preferably used to define the channels 553 if the base 51 has a long length. Also, a drilling method can be used to define the channels 553 if the base 51 has a short length.

Step 75 is described in detail as follows: a broaching method is preferably used to define the groove-type capillary wick structure 554 if the base 51 has a long length. If the base 51 has a short length, the capillary wick structure 554 is preferably selected from a group consisting of sintered-type capillary wick structure, a meshed-type capillary wick structure, or a composite capillary wick structure.

Step 77 and step 79 are described in detail as follows: using the lid 551 to seal the left end of the channel 553 by soldering the lid 551 to left side the base 51 over the left end of the channel 553, then injecting the working liquid into the channel 553. Then the flat, round portion of the lid 552 5521 is soldered to the right side of the base 51 around the right end of the channel 553. The central hole of the flat, round portion 5521 communicates the channel 553 with an outside environment. Finally, the channel 553 is vacuumed through the central hole of the flat, round portion 5521, and then the plug 5522 is hermetically soldered in the central hole of the flat, round portion 5521 to seal the right end of the channel 553 to form the heat pipe structure 55. The lid 552 thus has the flat, round portion 5521 and the plug 5522 inserted into the center of the flat, round portion 5521.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lamp comprising:
a heat dissipation device comprising:
a base including at least one channel therein, a capillary wick structure being formed on a wall of the base defining the at least one channel, the at least one channel containing working liquid therein, two ends of the at least one channel being sealed to form a heat pipe structure in the base, the base forming a first flat mounting surface; and
a plurality of fins extending from an outer side of the base; and
a plurality of LEDs mounted on the first flat mounting surface of the base.

2. The LED lamp as claimed in claim 1, wherein a front side of the base is used to form the first flat mounting surface for mounting the LEDs thereon, the fins extend from at least one of upper and lower sides of the base, and the at least one channel is adjacent to the front side and the at least one of the upper and lower sides of the base.

3. The LED lamp as claimed in claim 2, wherein the base has an elongated shape, the at least one channel extends through the base along a lengthwise direction from one end to the other end of the base.

4. The LED lamp as claimed in claim 1, wherein two lids are used to seal the ends of the at least one channel respectively by soldering the two lids to the base covering the ends of the at least one channel.

5. The LED lamp as claimed in claim 4, wherein the at least one channel has a circular cross section, one of the lids has a flat, round shape, another one of the lids has a flat, round portion and a plug extending outwardly from a center of the flat, round portion, the flat, round portion surrounds a corresponding end of the at least one channel, the plug seals the corresponding end of the at least one channel.

6. The LED lamp as claimed in claim 1, wherein the capillary wick structure is selected from a group consisting of a sintered-type capillary wick structure, a meshed-type capillary wick structure, a composite capillary wick structure.

7. The LED lamp as claimed in claim 1, wherein a plurality of micro grooves are defined in the at least one channel so as to form a groove-type capillary wick structure.

8. The LED lamp as claimed in claim 1, wherein a protrusion is formed on a middle of a rear side of the base and extends along a lengthwise direction of the base, a circular hole is defined through the protrusion, and a wire is received in the hole for supply power to the LEDs.

9. The LED lamp as claimed in claim 1, wherein a number of the at least one channel is two, the fins extend from upper and lower sides of the base, the two channels are adjacent to the upper and lower sides of the base respectively as well as being adjacent to the front side of the base.
